(19) United States
(12) Patent Application Publication
(10) Pub. No.: US 2026/0091502 A1
(43) Pub. Date: Apr. 2, 2026

(54) VISION-LANGUAGE MODEL FOR DETECTING AND REASONING OVER FAILURES IN ROBOTIC MANIPULATION

(71) Applicant: NVIDIA Corporation, Santa Clara, CA (US)

(72) Inventors: Jiafei Duan, Seattle, WA (US); Yijie Guo, Seattle, WA (US); Ajay Mandlekar, Cupertino, CA (US); Dieter Fox, Seattle, WA (US)

(21) Appl. No.: 19/222,877

(22) Filed: May 29, 2025

Related U.S. Application Data
(60) Provisional application No. 63/701,405, filed on Sep. 30, 2024.

(51) Int. Cl. B25J 9/16

(52) U.S. Cl. CPC B25J 9/1697

(57) ABSTRACT

Foundation models such as VLMs and LLMs are increasingly being used to address open-world tasks in robotics. While these models excel at task execution, they often face challenges in detecting and reasoning over failures, which are skills that are crucial for navigating dynamic and complex environments. The present disclosure provides a VLM that detects and reasons about failures in robotic manipulation using natural language, where the natural language feedback can then be used for improving downstream task performance through error correction.

### RELATED APPLICATION(S)

This application claims the benefit of U.S. Provisional Application No. 63/701,405 (Attorney Docket No. NVIDP1420+/24-SE-1158US01), titled “VISION-LANGUAGE-MODEL FOR DETECTING AND REASONING OVER FAILURES IN ROBOTIC MANIPULATION” and filed Sep. 30, 2024, the entire contents of which is incorporated herein by reference.

### TECHNICAL FIELD

The present disclosure relates to robotic manipulation.

### BACKGROUND

In recent years, foundation models have made remarkable progress across various domains, demonstrating their ability to handle open-world tasks. These models, including large language models (LLMs) and vision-language models (VLMs), have shown proficiency in interpreting and executing human language instructions, producing accurate predictions and achieving strong task performance. However, despite these advancements, key challenges remain-particularly with hallucinations, where models generate responses that deviate from truth. Unlike humans, who can intuitively detect and adjust for such errors, these models often lack the mechanisms for recognizing their own mistakes.

Learning from failure is a fundamental aspect of human intelligence. Regardless of the task, the ability to reflect on and adjust based on feedback is essential for improvement. In machine learning, this process is mirrored through techniques like Reinforcement Learning with Human Feedback (RLHF), where human oversight helps guide models toward desired outcomes. This feedback loop plays a critical role in aligning generative models with real-world objectives. However, a crucial question persists: How can we equip these models with the capability to detect and learn from their own errors without a human in the loop? This need is particularly pressing in robotics, where foundation models such as VLMs and LLMs are increasingly used to address open-world tasks. Recent advancements have enabled these models to tackle spatial reasoning, object recognition, and multimodal problem-solving-skills vital for robotic manipulation. VLMs and LLMs are already being integrated to automate reward generation for reinforcement learning, develop task plans for motion planning, and even generate zero-shot robot trajectories.

While these models excel at task execution, they often face challenges in detecting and reasoning over failures, which are skills that are crucial for navigating dynamic and complex environments. For example, if a robot drops an object mid-task, a human observer would immediately recognize the error and take corrective action. Robots, on the other hand, are not currently empowered with similar capabilities, and thus cannot detect and learn from their mistakes.

There is thus a need for addressing these issues and/or other issues associated with the prior art. For example, there is a need to provide a VLM that detects and reasons about failures in robotic manipulation using natural language, where the natural language feedback can then be used for improving downstream task performance through error correction.

### SUMMARY

A method, computer readable medium, and system are disclosed to detect and reason about a robotic manipulation failure. An input depicting performance of a robotic manipulation task is processed by a vision language model to detect a failure of the robotic manipulation task and to generate a natural language explanation of the failure. The explanation is output as feedback to a robotics application for use in improving a future performance of the robotic manipulation task.

### BRIEF DESCRIPTION OF THE DRAWINGS

FIG. 1A illustrates a method for using a VLM to detect and reason about a robotic manipulation failure, in accordance with an embodiment.

FIG. 1B illustrates a method for training a VLM to detect and reason about failures in robotic manipulation tasks through natural language, in accordance with an embodiment.

FIG. 2 illustrates a system for improving robotic manipulation, in accordance with an embodiment.

FIG. 3 illustrates a training pipeline for the VLM of FIG. 2, in accordance with an embodiment.

FIG. 4 illustrates a process for using feedback from a robotic manipulation failure to provide sub-task verification, in accordance with an embodiment.

FIG. 5 illustrates a process for using feedback from a robotic manipulation failure to provide improved task-plan generation, in accordance with an embodiment.

FIG. 6 illustrates a process for using feedback from a robotic manipulation failure to provide improved reward function generation, in accordance with an embodiment.

FIG. 7A illustrates inference and/or training logic, according to at least one embodiment.

FIG. 7B illustrates inference and/or training logic, according to at least one embodiment.

FIG. 8 illustrates training and deployment of a neural network, according to at least one embodiment.

FIG. 9 illustrates an example data center system, according to at least one embodiment.

### DETAILED DESCRIPTION

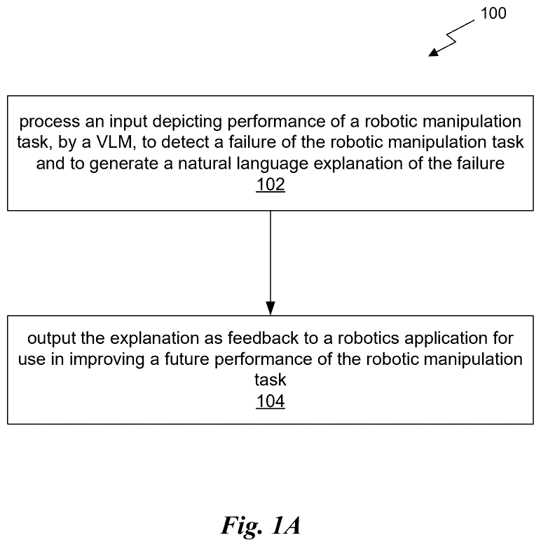

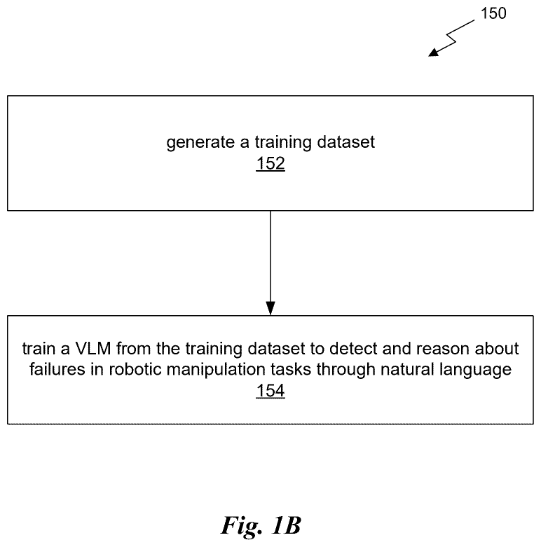

FIG. 1A illustrates a method 100 for using a VLM to detect and reason about a robotic manipulation failure, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, an input depicting performance of a robotic manipulation task is processed by a VLM to detect a failure of the robotic manipulation task and to generate a natural language explanation of the failure. With respect to the present description, the robotic manipulation task refers to one or more (e.g. a sequence of) actions which when performed by a robot achieve a robotic goal. In an embodiment, the one or more actions may be defined in a motion plan for the robot. In an embodiment, the robotic manipulation task may be planned by a robotics application. In an embodiment, the robotics application may control the robot to perform the robotic manipulation task.

The robot refers to an autonomous moving object that is configured to perform at least one robotic manipulation task. In an embodiment, the robot may be a real-world robot, such as an autonomous vehicle, articulated robot, etc. In this embodiment, performance of the robotic manipulation task may be a real-world performance of the robotic manipulation task by the robot. In another embodiment, the robot may be a virtual robot, such as a character or other autonomous moving object in a virtual world. In this embodiment, performance of the robotic manipulation task may be a simulated performance of the robotic manipulation task by the virtual robot.

The input that depicts performance of the robotic manipulation task refers a visual input depicting at least a portion of the performance of the robotic manipulation task by the robot. In an embodiment, the input may include at least one image frame depicting the performance of the robotic manipulation task. In an embodiment where the robotic manipulation task is comprised two or more sub-tasks, the image frame(s) may depict performance of a sub-task of the robotic manipulation task.

In an embodiment, the input may further include a text prompt. The text prompt may include one or more instructions for processing the depiction of the performance of the robotic manipulation task to detect the failure of the robotic manipulation task and to generate the natural language explanation of the failure. In an embodiment, the text prompt may describe a language specification for generating the natural language explanation of the failure. As described below in more detail, a (downstream) robotics application may be configured with the language specification, such that the robotics application may be capable of understanding (e.g. processing) the natural language explanation of the failure.

As mentioned, a VLM processes the input to detect the failure of the robotic manipulation task and to generate the natural language explanation of the failure. The VLM refers to a pre-trained VLM configured to detect, from a depiction of a performance of a robotic manipulation task, a failure of the depicted robotic manipulation task and to generate a natural language explanation of the failure. The VLM may be trained as described below with reference to the method 150 of FIG. 1A.

The failure of the robotic manipulation task refers to an unsuccessful completion of one or more actions by the robot during the performance of the robotic manipulation task. For example, the VLM may be configured to detect a success or failure of the performance of each action in the robotic manipulation task. The VLM may detect the failure of the robotic manipulation task by analyzing the input depicting the performance of the robotic manipulation task.

The natural language explanation of the failure refers to a reasoning for the failure that is generated in a natural language. In an embodiment, the explanation of the failure may indicate which action of the robotic manipulation task failed and a cause for the failure. Just by way of example, the cause for the failure may be an incorrect positioning of the robot when performing the action.

In operation 104, the explanation is output as feedback to a robotics application for use in improving a future performance of the robotic manipulation task. In an embodiment, the VLM may be integrated with the robotics application. For example, the VLM may be a component of the robotics application. In another embodiment, the VLM may be separate from the robotics application but may be interface the robotics application for providing the feedback thereto.

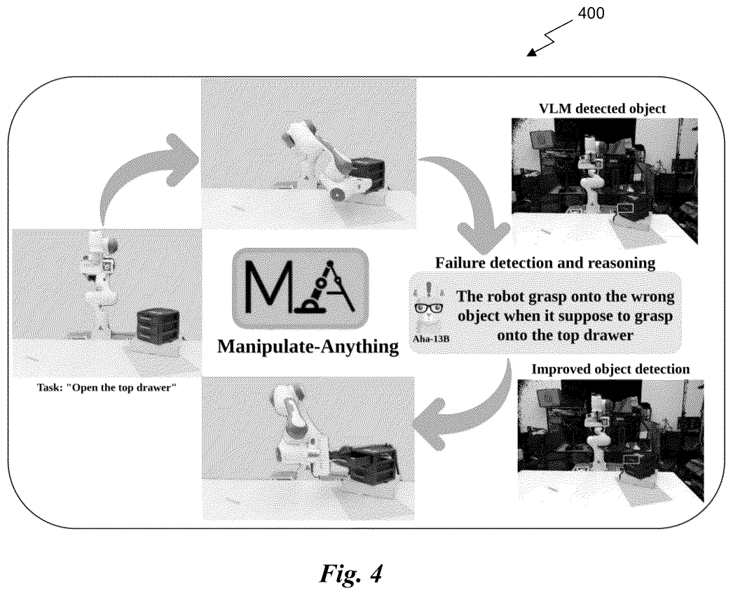

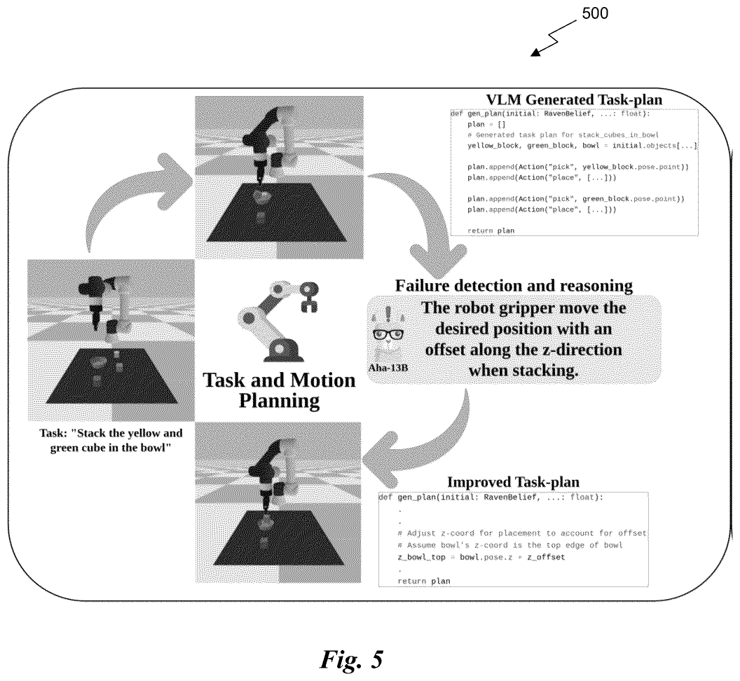

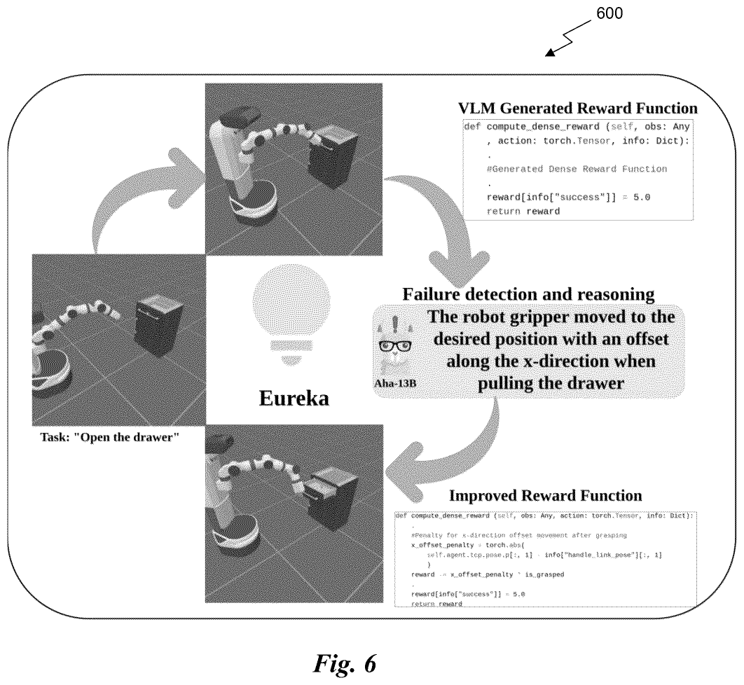

In an embodiment, the robotics application may use the feedback to verify success of one or more sub-tasks of the robotic manipulation task. An embodiment of using the feedback to provide sub-task verification will be described below in more detail with reference to FIG. 4. In an embodiment, the robotics application may use the feedback to refine task-plan generation for a task and motion planning function of the robotics application. An embodiment of using the feedback to provide improved task-plan generation will be described below in more detail with reference to FIG. 5. In an embodiment, the robotics application may use the feedback as a parameter of a reward function to compute a reward signal for reinforcement learning by the robotics application. An embodiment of using the feedback to provide improved reward function generation will be described below in more detail with reference to FIG. 6.

As an option, the method 100 may be implemented such that the explanation is output without necessarily being output to the robotics application. In an embodiment, the explanation may be output to a human. For example, the explanation may be output to a human as feedback for the performance of the robotic manipulation task. This may allow the human to make adjustments within the robotic application, to make adjustments to the robot, etc., based on the explanation, by way of example.

FIG. 1B illustrates a method 150 for training a VLM to detect and reason about failures in robotic manipulation tasks through natural language, in accordance with an embodiment. The method 150 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 150. In another embodiment, a non-transitory computer-readable media may store computer instructions which when executed by one or more processors of a device cause the device to perform the method 150.

In operation 152, a training dataset is generated. With respect to the present method 150, the training dataset is generated is generated in particular by procedurally altering inputs depicting performances of a plurality of robotic manipulation tasks to form depictions of a plurality of failed robotic manipulation tasks, and for each depiction of a failed robotic manipulation task of the plurality of failed robotic manipulation tasks, generating a pair of query and answer prompts.

In an embodiment, the inputs may include keyframes depicting the performances of the plurality of robotic manipulation tasks. In an embodiment, at least one of the inputs may be procedurally altered by perturbing the keyframes. In an embodiment, at least one of the inputs may be procedurally altered by reordering a keyframe sequence. In an embodiment, at least one of the inputs may be procedurally altered by making an object substitution.

In an embodiment, the inputs may be altered based on a plurality of different predefined failure modes such that the depictions of the plurality of failed robotic manipulation tasks correspond to the plurality of different predefined failure modes. In an embodiment, the plurality of different predefined failure modes may include one or more of incomplete grasp failure, inadequate grip retention failure, incorrect rotation failure, missing rotation failure, wrong action sequence failure, or wrong target action failure.

In an embodiment, configuration files may be generated for use in altering the inputs. In an embodiment, for each robotic manipulation task of the plurality of robotic manipulation tasks depicted by the inputs, a set of configuration files may be generated to indicate: one or more failure modes of the plurality of different predefined failure modes that are applicable to the robotic manipulation task, parameters of the robotic manipulation task, and alterations to made to the inputs to induce failure of the robotic manipulation task.

In an embodiment, the query and answer prompts may be generated using language templates that describe the robotic manipulation tasks. In an embodiment, the query and answer prompts may be further generated based on a plurality of different predefined failure modes that were used as a basis for altering the inputs to form the depictions of the plurality of failed robotic manipulation tasks.

In operation 154, a VLM is trained from the training dataset to detect and reason about failures in robotic manipulation tasks through natural language. In an embodiment, the vision language model may be co-trained with publicly available visual question-answering datasets. In an embodiment, the VLM may be a pretrained VLM. In an embodiment, the VLM may be trained by fine-tuning only an LLM base model while freezing other components of the VLM such as an image encoder and text prompt tokenizer.

Further embodiments will now be provided in the description of the subsequent figures. It should be noted that the embodiments disclosed herein with reference to the method 100 of FIG. 1 may apply to and/or be used in combination with any of the embodiments of the remaining figures below.

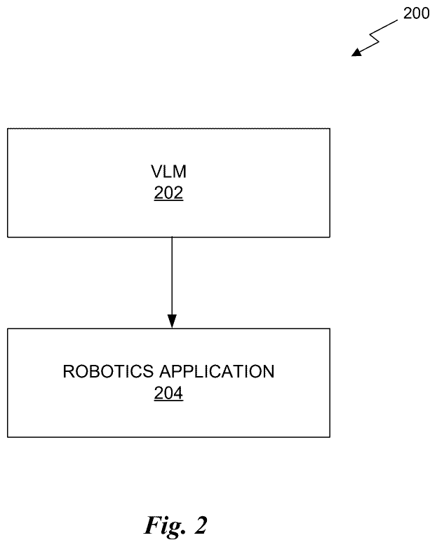

FIG. 2 illustrates a system 200 for improving robotic manipulation, in accordance with an embodiment. The system 200 may be implemented in the context of the embodiments described above.

As shown, the system 200 includes a VLM 202 and a robotics application 204. The VLM 202 and the robotics application 204 may execute on a same computing device, in an embodiment. For example, the VLM 202 and the robotics application 204 may be components of a robotic system (not shown) that includes a robot capable of being autonomously controlled via the robotics application 204. In another embodiment, the VLM 202 may execute on a computing device that is separate from a computing device (or robotic system) on which the robotics application 204 executes.

The VLM 202 is configured to process an input depicting performance of a robotic manipulation task to detect a failure of the robotic manipulation task and to generate a natural language explanation of the failure. The VLM 202 outputs the explanation as feedback to the robotics application 204. The robotics application 204 is configured to use the feedback for improving a future performance of the robotic manipulation task.

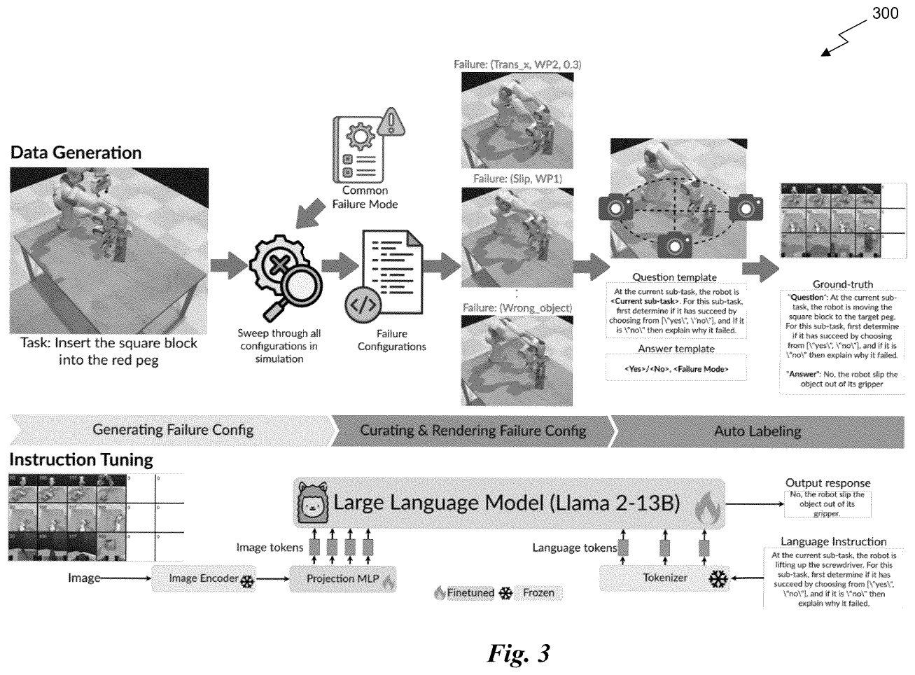

FIG. 3 illustrates a training pipeline 300 for the VLM 202 of FIG. 2, in accordance with an embodiment.

### Data Generation

To curate an instruction-tuning dataset of failure trajectories for robotic manipulation tasks, prevalent failure modes existing for robots are first identified. In an embodiment, these include: incomplete grasp, inadequate grip retention, misaligned keyframe, incorrect rotation, missing rotation, wrong action sequence, and wrong target object, as described in Table 1.

TABLE 1
Incomplete Grasp (No_Grasp) Failure: No_Grasp is an object-centric failure that occurs when
the gripper reaches the desired grasp pose but fails to close before proceeding to the next
keyframe.
Inadequate Grip Retention (Slip) Failure: Slip is an object-centric failure that happens after the
object has been successfully grasped. As the gripper moves the object to the next task-specific
keyframe, the grip loosens, causing the object to slip from the gripper.
Misaligned keyframe (Translation) Failure: This action-centric failure occurs when the gripper
moves toward a task keyframe, but a translation offset along the X, Y, or Z axis causes the task
to fail.
Incorrect Rotation (Rotation) Failure: Rotation is an action-centric failure that occurs when the
gripper reaches the desired translation pose for the sub-task keyframe, but there is an offset in
roll, yaw, or pitch, leading to task failure.
Missing Rotation (No_Rotation) Failure: No_Rotation is an action-centric failure that happens
when the gripper reaches the desired translation pose but fails to achieve the necessary rotation
(roll, yaw, or pitch) for the sub-task, resulting in task failure.
Wrong Action Sequence (Wrong_action) Failure: Wrong_action is an action-centric failure that
occurs when the robot executes actions out of order, performing an action keyframe before the
correct one. For example, in the task put_cube_in_drawer, the robot moves the cube toward the
drawer before opening it, leading to task failure.
Wrong Target Object (Wrong_object) Failure: Wrong_object is an object-centric failure that
occurs when the robot acts on the wrong target object, not matching the language instruction. For
example, in the task pick_the_red_cup, the gripper picks up the green cup instead, leading to task
failure.

The dataset used to train the VLM 202 is generated using a keyframe-based formulation to dynamically induce failure modes during task execution. Keyframes for task demonstrations are obtained, which enables flexibility in both object manipulation (handling tasks with varying objects) and the sequence of actions (altering the execution order of keyframes). Then, task-specific trajectory modifications are made through keyframes perturbations, object substitutions, and reordering of keyframe sequences. This framework systematically generates failure trajectories aligned with the taxonomy defined in Table 1, yielding a curated dataset of failure-question pairs.

To generate the dataset, all keyframes in each task are systematically swept through, considering all potential configurations of the seven failure modes that could result in overall task failure. By leveraging a success condition checker in the simulation, YAML-based configuration files are procedurally generated by sweeping through each failure mode across all keyframes. These files provide details on potential failure modes, parameters (such as distance, task sequence, gripper retention strength, etc.), and corresponding keyframes that should be perturbed to induce failure. Additionally, language templates are incorporated to describe what the robot is doing between consecutive keyframes. Using these descriptions along with the failure modes, question-answer pairs for each corresponding failure mode can be systematically curated.

For specific failure modes, No_Grasp is implemented by omitting gripper open/close commands at the relevant keyframes, effectively disabling gripper control. Slip introduces a timed release of the gripper shortly after activation. Translation and Rotation perturb the position and orientation of a keyframe, respectively, while No_Rotation constrains the keyframe's rota-tional axis. Wrong_Action reorders keyframe activations to simulate incorrect sequencing, and Wrong_Object reassigns the keyframes intended for one object to another, maintaining the relative pose to mimic improper object manipulation.

### Failure Reasoning Formulation

Unlike previous solutions that primarily focus on detecting task success as binary classification problem, the present embodiments approach failure reasoning by first predicting a binary success condition (“Yes” or “No”) of the given sub-task based on a language specification and an input image prompt. If the answer is “No,” the VLM 202 is expected to generate a concise, free-form natural language explanation detailing why the task is perceived as a failure.

To formulate failure reasoning, the VLM 202 is prompted to analyze the trajectory failures at the current sub-task and provide reasoning for why or what led to the failure. Manipulation task trajectories are defined as a series of sub-tasks {S₀, S₁, S₂, . . . , Sₜ}, where each sub-task is represented by two consecutive keyframes. For example, in a task like “stacking cubes,” a sub-task could represent a primitive action, such as ‘picking up the cube.’ For the input formulation used in the VLM 202 for instruction fine-tuning and evaluation, a query prompt with an input image is used for prompting the VLM 202. The query prompt is generated using a template corresponding to the current sub-task the robot is performing. To capture the temporal relationships within the action sequence, the input image is constructed by selecting a single frame that represents the robot's trajectory up to the current sub-task and concatenating it with frames from other viewpoints in the rollout sequence.

This input frame is built by concatenating all keyframes up to the current sub-task in temporal order, from left to right, with any remaining keyframes replaced by white image patches. To mitigate occlusions, all the available camera viewpoints are also included, concatenating them alongside the temporal sequence, a detailed task description is provided in the prompt. The image data is structured as a matrix I, where each row corresponds to a different camera viewpoint {V₀, V₁, . . . , Vₙ} and each column captures the temporal sequence of keyframes {S₀, S₁, S₂, . . . , Sₜ}. The matrix I is defined per Equation 1.

$$I = ( \begin{matrix}{I}_{{V}_{0} {S}_{0}} & {I}_{{V}_{0} {S}_{1}} & ⋯ & {I}_{{V}_{0} {S}_{t}} \\ {I}_{{V}_{1} {S}_{0}} & {I}_{{V}_{1} {S}_{1}} & ⋯ & {I}_{{V}_{1} {S}_{t}} \\ ⋮ & ⋮ & ⋱ & ⋮ \\ {I}_{{V}_{n} {S}_{0}} & {I}_{{V}_{n} {S}_{1}} & ⋯ & {I}_{{V}_{n} {S}_{t}}\end{matrix} ) \qquad Equation 1$$

Where I_{V}_{ᵢ}_{S}_{ⱼ}, represents the image from viewpoint V₁ at sub-task Sⱼ, this formulation for curating images serves as a general approach for formatting all datasets used for fine-tuning and evaluation. This structured input enables consistent handling of data across different tasks and viewpoints. Overall, the failure reasoning problem is to prompt the VLM 202 with sub-task description and keyframe trajectory image to predict the success condition and language description of failure reason for each sub-task.

### Synthetic Data for Instruction-Tuning

To facilitate the instruction-tuning, failure demonstration data is systematically generated. To achieve this, an environment wrapper is used which can be applied to any robot manipulation simulator. The wrapper systematically perturbs successful robot trajectories for manipulation tasks, transforming them into failure trajectories with various modes of failure as depicted in FIG. 3 (Top image). Using this wrapper, a training dataset is obtained by alternating across different tasks in the selected simulator, resulting in failure image-text pairs. Furthermore, co-finetuning may be crucial to the success of instruction fine-tuning of the VLM 202. Therefore, in addition to the training dataset, the VLM 202 may be co-finetuned with general visual question-answering (VQA) datasets sourced from internet data, which helps the VLM 202 retain pre-trained knowledge.

### Instruction Fine-Tuning

As depicted in FIG. 3 (Bottom image), the model architecture includes an image encoder, a linear projector, a language tokenizer, and a transformer-based language model. The image encoder processes images into tokens, which are projected by a 2-layer linear into the same space as the language tokens. These multimodal tokens are then concatenated and passed through the language transformer. All components are initialized with pre-trained weights. During fine-tuning, only the projector and transformer weights are updated, while the vision encoder and tokenizer remain frozen. The VLM 202 operates autoregressively, with the objective of predicting response tokens and a special token marking the boundary between instruction and response.

### Training Result

The training pipeline 300 configures an open-source VLM 202 that detects and reasons about failures in robotic manipulation using natural language. By framing failure detection as a free-form reasoning task, the VLM 202 not only identifies failures but also generates detailed explanations. This approach allows the VLM 202 to adapt to various robots, camera viewpoints, tasks, and environments in both simulation and real-world scenarios.

Moreover, the VLM 202 integrates seamlessly into a VLM-guided robotic application 204, providing failure feedback to improve reward functions, enhancing task and motion planning, and/or verifying sub-task success in zero-shot robotic manipulation. These three downstream tasks, which use the feedback from the VLM 202 for improving downstream task performance through error correction, are described in more detail below with reference to FIGS. 4-6.

FIG. 4 illustrates a process 400 for using feedback from a robotic manipulation failure to provide sub-task verification, in accordance with an embodiment.

As shown, a robotic manipulation task is performed and the VLM 202 detects and reasons about a failure of a performed robotic manipulation task to generate an explanation for the failure, per any of the embodiments described above with reference to FIGS. 1-3. In the present embodiment, the robotic manipulation task may be a sub-task of a greater task. The explanation is provided as feedback for use by a sub-task verification module of the robotics application 204 to decide whether a sub-task of the robotic manipulation task has been successfully performed. This process may be repeated for each sub-task of the greater task. In an embodiment, use of the VLM 202 for sub-task verification may be used in the context of zero-shot robotic manipulation.

FIG. 5 illustrates a process 500 for using feedback from a robotic manipulation failure to provide improved task-plan generation, in accordance with an embodiment.

As shown, a task (or motion) plan is generated by a VLM of a robotics application 204. A robotic manipulation task is performed in accordance with the task plan and the VLM 202 detects and reasons about a failure of a performed robotic manipulation task to generate an explanation for the failure, per any of the embodiments described above with reference to FIGS. 1-3. The explanation is provided as feedback for use by the VLM of the robotics application 204 to improve the task plan. The improved task plan can then be used by the robotics application 204 for future performance of the robotic manipulation task.

FIG. 6 illustrates a process 600 for using feedback from a robotic manipulation failure to provide improved reward function generation, in accordance with an embodiment.

As shown, a reward function is generated by a VLM. In an embodiment, the reward function is used by a robotics application 204 for reinforcement learning. The VLM 202 detects and reasons about a failure of a performed robotic manipulation task to generate an explanation for the failure, per any of the embodiments described above with reference to FIGS. 1-3. The explanation is provided as feedback for use by the VLM of the robotics application 204 to improve the reward function. The improved reward function can then be used by the robotics application 204 for reinforcement learning, to optimize a future performance of the robotic manipulation task.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

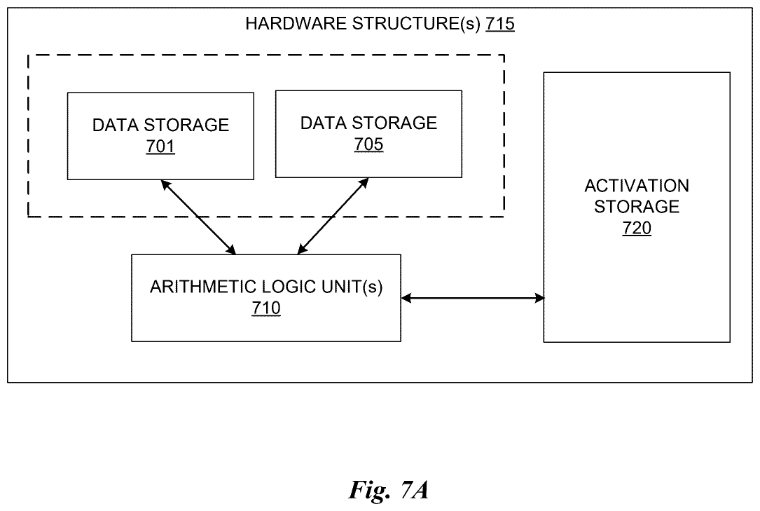

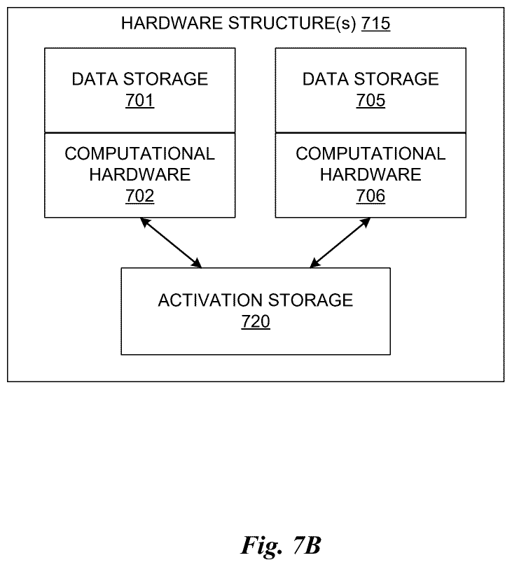

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

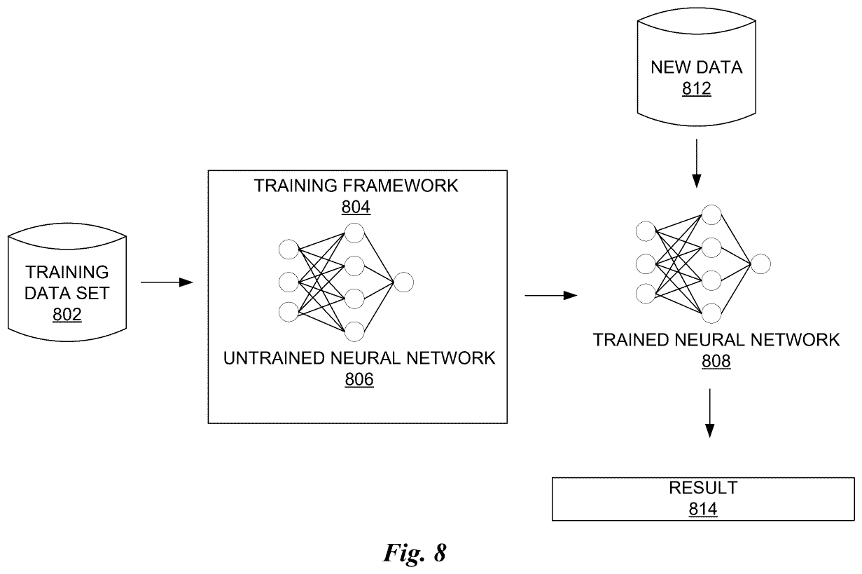

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

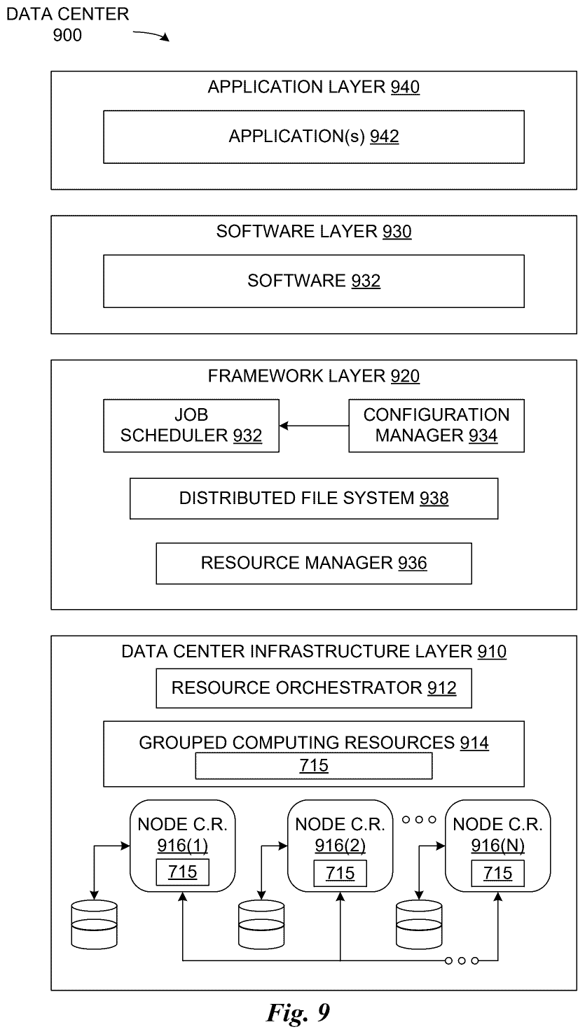

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for detecting and reasoning about a robotic manipulation failure. In accordance with FIGS. 1-6, embodiments may provide a VLM usable for performing inferencing operations and for providing inferenced data. The VLM may be stored (partially or wholly) in one or both of data storage 701 and 705 in inference and/or training logic 715 as depicted in FIGS. 7A and 7B. Training and deployment of the VLM may be performed as depicted in FIG. 8 and described herein. Distribution of the VLM may be performed using one or more servers in a data center 900 as depicted in FIG. 9 and described herein.

What is claimed is:

1. A method, comprising:
at a device:
processing an input depicting performance of a robotic manipulation task, by a vision language model, to detect a failure of the robotic manipulation task and to generate a natural language explanation of the failure; and
outputting the explanation as feedback to a robotics application for use in improving a future performance of the robotic manipulation task.

2. The method of claim 1, wherein the input includes at least one image frame depicting the performance of the robotic manipulation task.

3. The method of claim 2, wherein the at least one image frame depicts performance of a sub-task of the robotic manipulation task.

4. The method of claim 2, wherein the input further includes a text prompt describing a language specification for generating the natural language explanation of the failure.

5. The method of claim 1, wherein the performance of the robotic manipulation task is a real-world performance of the robotic manipulation task by a robot.

6. The method of claim 1, wherein the performance of the robotic manipulation task is a simulated performance of the robotic manipulation task by a virtual robot.

7. The method of claim 1, wherein the robotic manipulation task is planned by the robotics application.

8. The method of claim 1, wherein the robotics application uses the feedback as a parameter of a reward function to compute a reward signal for reinforcement learning by the robotics application.

9. The method of claim 1, wherein the robotics application uses the feedback to refine task-plan generation for a task and motion planning function of the robotics application.

10. The method of claim 1, wherein the robotics application uses the feedback to verify success of one or more sub-tasks of the robotic manipulation task.

11. The method of claim 1, wherein the vision language model is integrated with the robotics application.

12. A system, comprising:
a non-transitory memory storage comprising instructions; and
one or more processors in communication with the memory, wherein the one or more processors execute the instructions to:
process an input depicting performance of a robotic manipulation task, by a vision language model, to detect a failure of the robotic manipulation task and to generate a natural language explanation of the failure; and
output the explanation as feedback to a robotics application for use in improving a future performance of the robotic manipulation task.

13. The system of claim 12, wherein the input includes at least one image frame depicting the performance of the robotic manipulation task.

14. The system of claim 12, wherein the robotic manipulation task is planned by the robotics application.

15. The system of claim 12, wherein the robotics application uses the feedback for at least one of:
computing a reward signal for reinforcement learning by the robotics application,
refining task-plan generation for a task and motion planning function of the robotics application, or
verifying success of one or more sub-tasks of the robotic manipulation task.

16. A non-transitory computer-readable media storing computer instructions which when executed by one or more processors of a device cause the device to:
process an input depicting performance of a robotic manipulation task, by a vision language model, to detect a failure of the robotic manipulation task and to generate a natural language explanation of the failure; and
output the explanation as feedback to a robotics application for use in improving a future performance of the robotic manipulation task.

17. The non-transitory computer-readable media of claim 16, wherein the input includes at least one image frame depicting the performance of the robotic manipulation task.

18. The non-transitory computer-readable media of claim 16, wherein the robotic manipulation task is planned by the robotics application.

19. The non-transitory computer-readable media of claim 16, wherein the robotics application uses the feedback for at least one of:
computing a reward signal for reinforcement learning by the robotics application,
refining task-plan generation for a task and motion planning function of the robotics application, or
verifying success of one or more sub-tasks of the robotic manipulation task.

20. A method, comprising:
at a device:
generating a training dataset by:
procedurally altering inputs depicting performances of a plurality of robotic manipulation tasks to form depictions of a plurality of failed robotic manipulation tasks, and
for each depiction of a failed robotic manipulation task of the plurality of failed robotic manipulation tasks, generating a pair of query and answer prompts; and
training a vision language model from the training dataset to detect and reason about failures in robotic manipulation tasks through natural language.

21. The method of claim 20, wherein the inputs include keyframes depicting the performances of the plurality of robotic manipulation tasks.

22. The method of claim 21, wherein at least one of the inputs is procedurally altered by perturbing the keyframes.

23. The method of claim 21, wherein at least one of the inputs is procedurally altered by reordering a keyframe sequence.

24. The method of claim 21, wherein at least one of the inputs is procedurally altered by making an object substitution.

25. The method of claim 20, wherein the inputs are altered based on a plurality of different predefined failure modes such that the depictions of the plurality of failed robotic manipulation tasks correspond to the plurality of different predefined failure modes.

26. The method of claim 25, wherein the plurality of different predefined failure modes include at least one of:
incomplete grasp failure,
inadequate grip retention failure,
incorrect rotation failure,
missing rotation failure,
wrong action sequence failure, or
wrong target action failure.

27. The method of claim 25, wherein configuration files are generated for use in altering the inputs.

28. The method of claim 27, wherein for each robotic manipulation task of the plurality of robotic manipulation tasks depicted by the inputs, a set of configuration files are generated to indicate:
one or more failure modes of the plurality of different predefined failure modes that are applicable to the robotic manipulation task,
parameters of the robotic manipulation task, and
alterations to made to the inputs to induce failure of the robotic manipulation task.

29. The method of claim 20, wherein the query and answer prompts are generated using language templates that describe the robotic manipulation tasks.

30. The method of claim 29, wherein the query and answer prompts are further generated based on a plurality of different predefined failure modes that were used as a basis for altering the inputs to form the depictions of the plurality of failed robotic manipulation tasks.

31. The method of claim 20, wherein the vision language model is co-trained with publicly available visual question-answering datasets.

32. A method, comprising:
at a device:
processing an input depicting performance of a robotic manipulation task, by a vision language model, to detect a failure of the robotic manipulation task and to generate a natural language explanation of the failure; and
outputting the explanation.
